(19) United States
(12) Patent Application Publication
(10) Pub. No.: US 2020/0158359 A1
(43) Pub. Date: May 21, 2020

(54) CLIMATE CONTROLLED SAFE SYSTEM

(71) Applicant: MEDIDOR GROUP LLC, Oakdale, CA (US)

(72) Inventor: David Ratchford, Oakdale, CA (US)

(21) Appl. No.: 16/654,528

(22) Filed: Oct. 16, 2019

Related U.S. Application Data
(63) Continuation of application No. 15/857,225, filed on Dec. 28, 2017, now abandoned.
(60) Provisional application No. 62/440,901, filed on Dec. 30, 2016.
(60) Provisional application No. 62/441,017, filed on Dec. 30, 2016.

(51) Int. Cl. F24F 11/00; E05B 65/00; E05G 1/00; A24F 25/00; F25D 17/04; E05G 1/024; F25D 29/00; F24F 11/30; F24F 11/70; G07C 9/00

(52) U.S. Cl. CPC F24F 11/0008; E05B 65/0075; E05G 1/00; A24F 25/00; F25D 17/042; F24F 2110/20; F25D 29/006; F24F 11/30; F24F 11/70; G07C 9/00563; F25D 2317/0413; E05G 1/024

(57) ABSTRACT

Provided are embodiments of a climate controlled safe system. The climate controlled safe system includes a safe body, a safe door pivotly coupled to the safe body, an insert removably coupled to the safe body, and wherein the insert further includes an insert body, an insert door pivotly coupled to the insert body, and further wherein the insert door includes a removable climate control unit and a removable hygrometer.

### CROSS-REFERENCE TO RELATED APPLICATIONS

This application is a continuation of U.S. patent application Ser. No. 15/857,225, filed Dec. 28, 2017, which claims priority pursuant to 35 U.S.C. § 119(e) to U.S. Provisional Patent Application No. 62/440,901, filed Dec. 30, 2016, and to U.S. Provisional Patent Application No. 62/441,017, filed Dec. 30, 2016, the disclosures of all of which are hereby incorporated in their entireties by reference.

### TECHNICAL FIELD

The claimed invention relates to storage devices, and in some aspects, to a storage device with controlled climate and controlled access.

### BACKGROUND

Although, with a striking 4.3 billion prescriptions filled and 374 billion dollars in sales, 2014 was a great year for business in prescription drugs, death rates from drug overdoses have never been higher. In the United States alone, 100 people die daily from drug overdoses. On the other hand, in a recent article published by countercurrentnews.com, States that have legalized medical marijuana saw a 25% drop in painkiller deaths between 1999 and 2010. The organic origin and healing properties of various herbs and plants, such as marijuana have been known, and used for over 10,000 years by some of the earliest human civilizations. Many herbs and plants have medical uses that are similar to more dangerous conventional drugs. Medical marijuana and other herbs and plants may be helpful in bettering the quality of life for chronic illness and other illnesses, while continuing to keep painkiller related deaths and other deaths related to the other medical substances low.

Unfortunately, the industry has failed to develop products geared toward preserving the healing and other properties of herbs and plants, such as cannabis, while keeping children safe. For example, emergency room visits by children, ages 2 to 18, who have taken cannabis, for example, have been increasing. With the increased use of herbs and plants with of all of the products in which the herbs and plants may be included (candy, cookies, drinks, bake pops, brownies, etc.), it may be desirable for adults to have access to their herbs and plants, while preventing children from having access.

There is also a fundamental lack of understanding of the shelf life and safe storage techniques of many medical and recreational substances, such as cannabis, fresh saffron, fresh vanilla, cloverleaf, tobacco, and various fresh teas. Unlike prescription drugs, which can have a shelf life of up to several years, herbs and plants, such as marijuana, need specific environmental conditions to maintain its potency and healing properties. Understanding how to create this environment will increase shelf life and will allow consumers to more thoroughly enjoy their herbs and plants, by keeping their herbs and plants fresher for a longer period of time.

Accordingly, there is a need for a secure storage device that also preserves the properties of herbs and plants.

### SUMMARY

Provided herein are embodiments of a climate controlled safe system. In some embodiments, the climate controlled safe system includes a safe body, a safe door pivotly coupled to the safe body, an insert removably coupled to the safe body, and wherein the insert further includes an insert body, an insert door pivotly coupled to the insert body, and further wherein the insert door includes a removable climate control unit and a removable hygrometer.

In some embodiments, the climate controlled safe system's insert body includes one or more rails for receiving one or more storage trays or one or more vertical storage boxes.

Other features and advantages of the present invention will be or will become apparent to one with skill in the art upon examination of the following figures and detailed description, which illustrate, by way of examples, the principles of the present invention.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, like reference numerals designate corresponding parts throughout the different views.

FIG. 1A illustrates an exemplary perspective view of a climate controlled safe system, according to some aspects of the disclosure.

FIG. 1B illustrates an exemplary front view of a climate controlled safe system, according to some aspects of the disclosure.

FIG. 1C illustrates another exemplary perspective view of a climate controlled safe system, according to some aspects of the disclosure.

FIG. 1D illustrates an exemplary front view of a climate controlled safe system holding a vertical storage box, according to some aspects of the disclosure.

FIG. 1E illustrates an exemplary block diagram of a climate controlled safe system, according to some aspects of the disclosure.

FIG. 2 illustrates an exemplary network within which a climate controlled safe system of FIG. 1 is used, according to some aspects of the disclosure.

FIG. 3 illustrates an exemplary block diagram of a user device used in the network of FIG. 2, according to some aspects of the disclosure.

FIG. 4 illustrates an exemplary block diagram of a server used in the network of FIG. 2, according to some aspects of the disclosure.

FIG. 5A illustrates an exemplary front view of a safe body of a climate controlled safe system, according to some aspects of the disclosure.

FIG. 5B illustrates another exemplary front view of a safe body of a climate controlled safe system, according to some aspects of the disclosure.

FIG. 6 illustrates an exemplary sectional side view of a safe body of a climate controlled safe system, according to some aspects of the disclosure.

FIG. 7 illustrates an exemplary sectional bottom view of a safe body of a climate controlled safe system, according to some aspects of the disclosure.

FIG. 8A illustrates an exemplary sectional front view of a safe insert of a climate controlled safe system, according to some aspects of the disclosure.

FIG. 8B illustrates an exemplary sectional side view of a safe insert of a climate controlled safe system, according to some aspects of the disclosure.

FIG. 8C illustrates an exemplary sectional top view of a safe insert of a climate controlled safe system, according to some aspects of the disclosure.

FIG. 9 illustrates an exemplary perspective view of a vertical storage box of a climate controlled safe system, according to some aspects of the disclosure.

### DETAILED DESCRIPTION

The below described figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

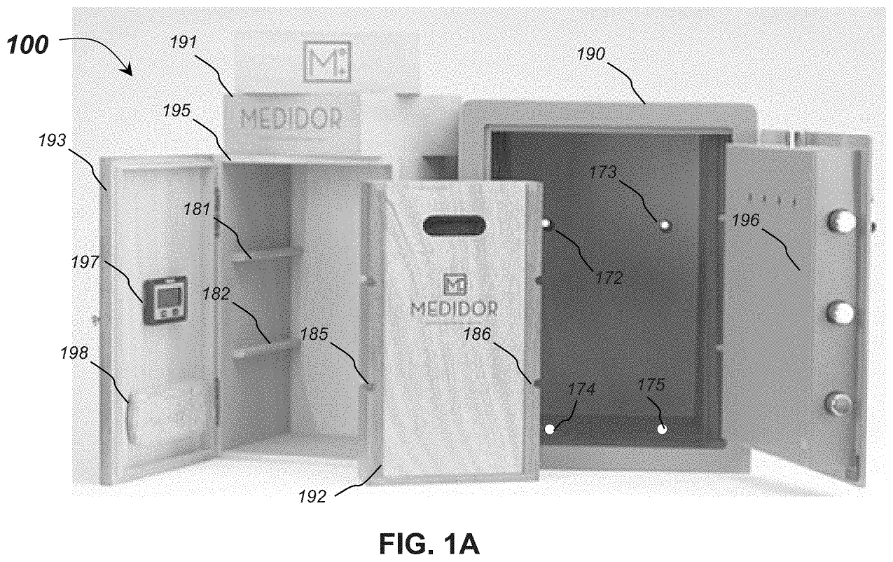

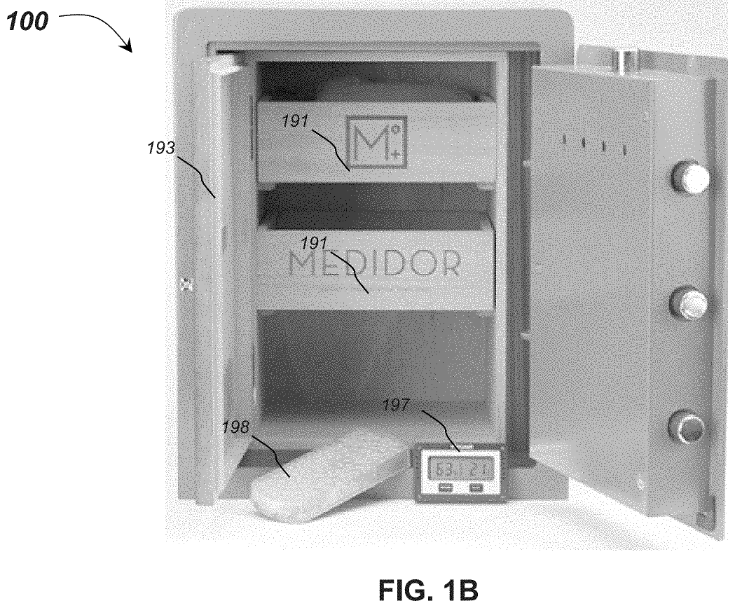

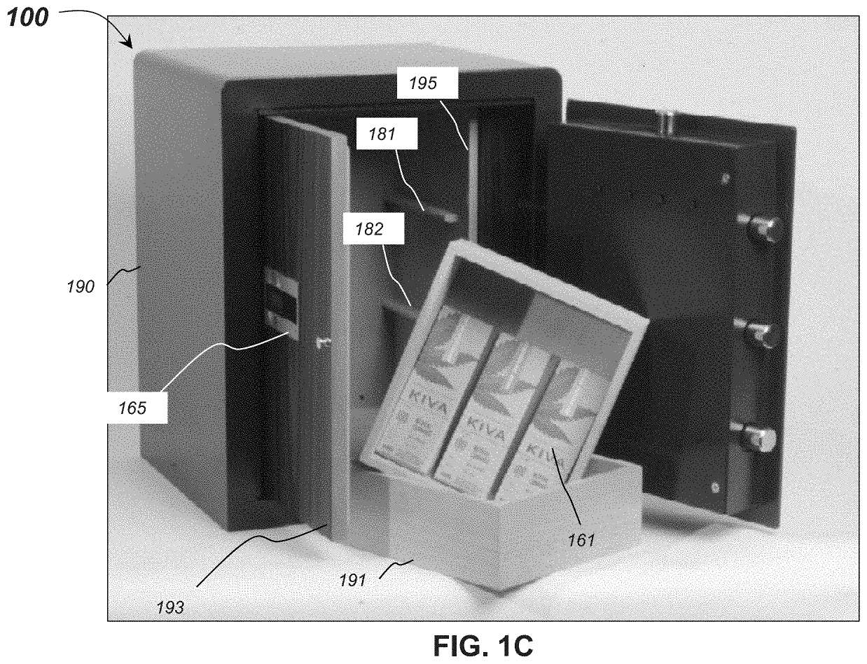

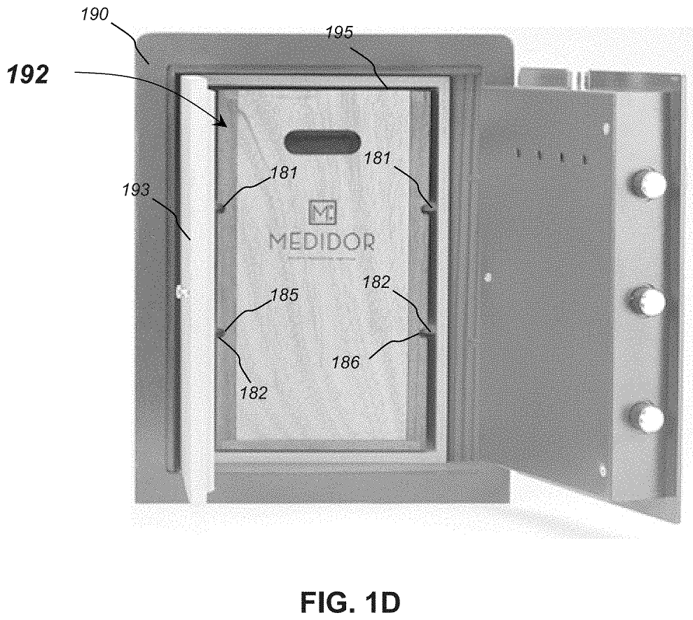

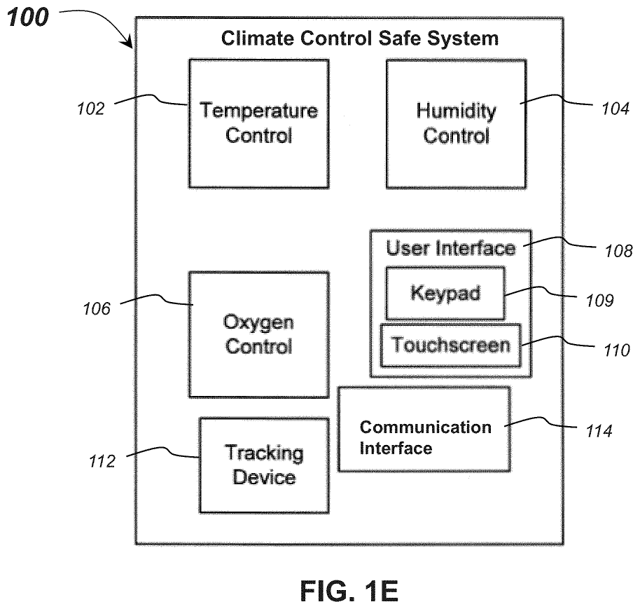

FIGS. 1 to 10 illustrate exemplary embodiments of a storage device system with controlled climate and controlled access. In some embodiments, the storage device system may keep plants and herbs (e.g., cannabis, fresh saffron, fresh vanilla, cloverleaf, tobacco, and various fresh teas) potent. The storage device system may do this by introducing advanced preservation technology. The storage device system may provide access control, temperature control, humidity control, oxygen control, or a combination thereof. The storage device system may maintain a steady, desirable temperature, moisture/humidity level, and oxygen level in the interior space; and it may protect contents from physical damage and deterioration from sunlight. In some embodiments, the storage device system is portable and includes a tracking device and communication capability. The storage device system may also be referred to herein as a climate control safe system.

In certain embodiments, the climate control safe system may include a safe body and a removable insert, or frame. In some embodiments, the insert may function similar to a humidor. The removable insert may receive one or more storage trays or storage boxes. In certain embodiments, the storage boxes may be inserted into the insert vertically.

In some embodiments, climate control mechanisms are removably installed on the inside face of the door of the insert.

It should be noted that although examples herein refer to storage of plants and herbs, other items may also be stored in the disclosed climate control safe system. These items may include those that benefit from climate control, for example, medicine, firearms, and so on.

FIG. 1A illustrates perspective view of an exemplary climate controlled safe system 100, according to some aspects of the disclosure. The safe system 100 may generally include a safe body 190, a safe body door 196 pivotly coupled to the safe body 190, and safe insert 195 (shown removed from the safe body 190). The safe insert 195 may receive, or store, one or more horizontal storage trays 191, or one or more vertical storage boxes 192. As shown, the door 193 (shown open) of the safe insert 195 is pivotly coupled to the insert 195 body. The insert 195 may include humidity measurement unit 197, e.g., a hygrometer, and a humidifier pack 198.

In some embodiments, the humidifier pack 198 may be provided with humidity control solution such as polyglycol solution. In some operations, the polyglycol solution may be poured (or dropped) over the humidifier pack 198 which will absorb the polyglycol solution. Other suitable humidity control mechanism and solution may also be used. With the humidifier pack 198 installed, the insert 195 may function similar to a humidor.

In some embodiments, either or both the measurement unit 197 or/and the humidifier pack 198 are removably coupled on the inside face of the inset door 193 as shown.

In some embodiments, the insert 195 may include a plurality of upper rails 181 and lower rails 182. Rails 181 and 182 may receive horizontal trays 191, where a bottom side of the tray 191 may slide and rest on the rails 181 or 182. In some embodiments, the height of the tray 191 is made so that at least three trays 191 may horizontally fit inside the insert 195 (e.g., with one resting on the bottom floor of the insert 195).

In certain embodiments, rails 181 and 182 may receive vertical storage boxes 192, where for example, grooves 185, 186 on opposite sides of the vertical box 192 may fitly slide into the corresponding rail 182 and an opposite rail (not shown; see FIG. 1D). As a result, box 192 is stored vertically inside in the insert 195. Another set of grooves may fitly slide into the corresponding rails 181 and opposite rail (not shown). In some embodiments, the depth (or thickness) of the box 192 is made so that up to three boxes 192 may vertically fit inside the insert 195.

In some embodiments, the back side of the safe body 190 may include apertures (holes) 172, 173, used to secure the safe body to a vertical structure, such as a wall. The bottom side of the safe body may also include apertures (holes) 174, 175 to secure the safe body to a horizontal structure, such as a floor. Attachment devices such as screws may be used. A user may remove the insert 195 to thereby expose the holes, and the user may secure the safe body 190, via the holes to a structure that is more difficult to move than the safe system 100. For example, the safe body 190 may be bolted to a wall and/or floor.

In some embodiments, the insert 195 may be made from wood. In other embodiments, any of a variety of materials may be used for the insert 195, such as plastic or metal.

FIG. 1B illustrates a front view of the exemplary climate controlled safe system 100, according to some aspects of the disclosure. FIG. 1B shows the measurement unit 197 and the humidifier pack 198 removed from the insert door 193. The measurement unit 197 and the humidifier pack 198 may be advantageously removed, for example, for maintenance, or to upgrade to new technologies.

FIG. 1C illustrates another exemplary perspective view of the climate controlled safe system 100, according to some aspects of the disclosure. As shown, the tray 191 may be used to store items 161, such as plants and herb products. The trays are shown removed from the rails 181, 182 and the insert 195. Also as shown, in some embodiments, the measurement unit 197 may have a display 165 visible on the outside face of the insert door 193. This is advantageous in that the user may observe the climate inside the insert without having to open the insert.

FIG. 1D illustrates an exemplary front view of the climate controlled safe system 100 holding one or more vertical storage boxes 192, according to some aspects of the disclosure. The upper rails 181 and lower rails 182 may receive vertical storage boxes 192, where for example, left grooves 185 and right grooves 186 on opposite sides of the vertical box 192 may fitly slide into the corresponding rails 181 and 182. As a result, box 192 is stored vertically inside in the insert 195. In some embodiments, the depth (or thickness) of the box 192 is made so that up to three boxes 192 may vertically fit inside the insert 195. Although shown as having four rails 181, 182 (two upper rails and two lower rails), the insert 195 may include more or less rails. Accordingly, the vertical boxes 192 may include the same corresponding number of grooves.

FIG. 1E illustrates an exemplary block diagram of the climate controlled safe system 100, according to some aspects of the disclosure. The climate controlled safe system 100 may provide a secure (e.g., out of the access of children or any unwanted or unauthorized person) place for storing plants, herbs, medicine, and the like, out of direct sunlight, in a cool and dry place, while monitoring and controlling humidity, temperature, and/or oxygen levels. The climate controlled safe system 100 may include climate control 102, humidity control 104, oxygen control 106, user interface 108, and tracking device 112. Temperature control 102 may include electronics and sensor for setting, monitoring, reporting, and controlling a desired temperature inside the safe system 100, and more particularly inside the insert 195.

Humidity control 104 may include electronics and sensor for setting, monitoring, reporting, and controlling a desired humidity level inside the safe system 100, and more particularly inside the insert 195. In some embodiments, the humidity control 104 may provide absolute humidity control. In some embodiments, the humidity control 104 may provide relative humidity control. Relative humidity is the amount of water vapor present in air expressed as a percentage of the amount needed for saturation at the same temperature. For example, the humidity of the safe may be kept at less than 60% humidity, such as between 30% or 40% and 60% or between 30% or 40% to 50% humidity (e.g., between 30% and 60% or between 40% and 50%), so that mold is unlikely to grow and optionally the temperature of the safe system 100 may be kept at between 5 degrees Celsius and 20 or 24 degrees Celsius or between 10 degrees Celsius and 20 or 24 degrees Celsius (e.g., between 5 and 24 degrees Celsius or between 10 and 20 degrees Celsius).

In some embodiments, the humidity may be measured and controlled by a humidifier 198 and hygrometer 197, as shown in figures above. In some embodiments, the humidifier and/or hygrometer may be removable. In some embodiments, the humidifier and hygrometer may be removably attached to the door of the safe insert 195, such as by a magnet, screws, snaps, or other structure for removably attaching the hygrometer and humidifier.

Oxygen control 106 may include electronics and sensor for setting, monitoring, reporting, and controlling a desired level of oxygen inside the safe system 100, and more particularly inside the insert 195.

In some embodiments, control and functions of the safe system 100 may be programmable from the user interface 108. The user interface 108 may include a keypad 109 and a display screen 110. In some embodiments, the display screen 110 may be a touchscreen. The keypad 109 and screen 110 may be used to access (e.g., open, close) the safe system 100, e.g., using an access key code.

In some embodiments, the safe system 100 may communicate with external or remote devices via communication interface 114. Communication interface 114 may provide wired or wireless communication, e.g., Bluetooth, WiFi, etc. In some embodiments, communication interface 114 may provide key access to the safe system 100.

In some embodiments, the safe system 100 may include a memory system that may include, for example, any one of, some of, any combination of, or all of a long term storage system, such as a hard drive; a short term storage system, such as random access memory; a removable storage system, such as a removable drive; and/or flash memory. The memory system may include one or more machine-readable mediums that may store a variety of different types of information. The term machine-readable medium is used to refer to non-transitory computer readable memory, capable carrying information that is readable by a machine. The memory system may store an application for communicating with external devices as described herein.

In some embodiments, the safe system 100 may include a processor system that may include any one of, some of, any combination of, or all of multiple parallel processors, a single processor, a system of processors having one or more central processors and/or one or more specialized processors dedicated to specific tasks. The processor system retrieves machine instructions from the memory system and implements the machine instructions. The processor system may implement software app stored in the memory system for performing functions described herein, for example, locking and unlocking the safe system 100, monitoring, controlling, and operating the safe system 100, and communicating with external devices as described herein.

In some embodiments, the safe system 100 may include tracking device 112. The tracking device 112 may provide location of the safe system 100 to a remote device, e.g., a server, a smart phone, etc. As a result, the safe system 100 may be quickly located if stolen or misplaced. The tracking device 112 may include RFID, GPS, internet technology, or a combination thereof.

The safe system 100 may provide self-diagnosis with indication of any faults. A non-volatile memory may retain all settings and parameters when power is off. In some embodiments, the safe system 100 may include a power supply (either AC and/or DC) and battery backup. In some embodiments, the sensors may always operate, even when there is no power.

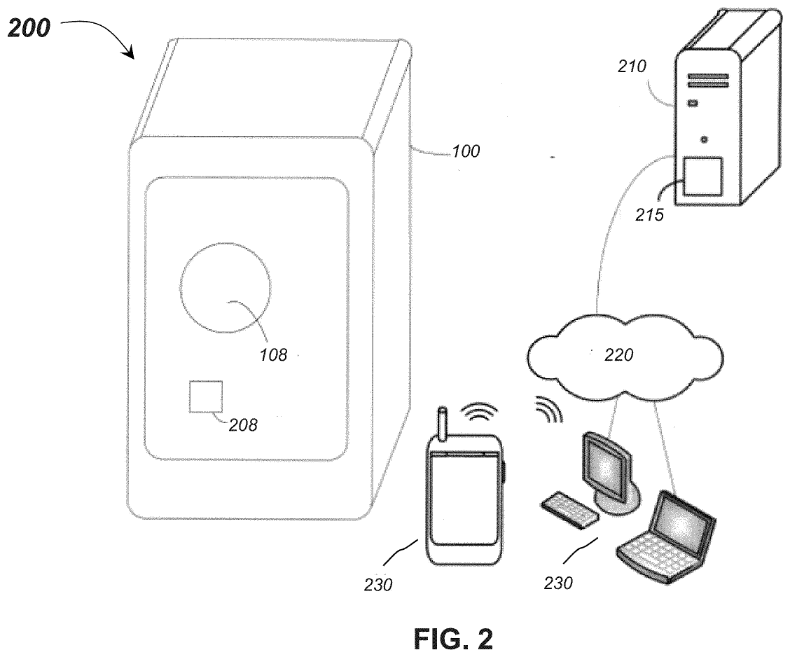

FIG. 2 illustrates an exemplary network 200 in which the climate control safe system 100 may operate, according to some aspects of the disclosure. A server 210 may be coupled to one or more user devices 230 over network 220, such as the Internet and/or a cellular-based wireless network. The server 210 may store a downloadable software application (or app) 215, which may be downloaded to user devices 230 and used for communicating between user devices 230, the climate control safe system 100, and the server 210. The user devices 230 may include, for example, mobile device, remote control, desktop or laptop device, or any device with communication capability. A mobile device may include smart phone, tablet, smart watch and other wearables, or other network ready device all known in the art. The user devices 230 may include one or more processors, memory, data storage, an operating systems, input/output interfaces, network interfaces, and other components and modules implemented in hardware, software or combinations thereof as are all known in the art. The user devices 230 include a processor and non-transitory computer readable memory storing instructions that, when executed by the processor may control and operate the safe system 100. User device 230 may be used to, for example, set the temperature, humidity level, open and/or close the safe system 100. These functions may be part of the app 215.

In some embodiments, the safe system 100 may include electronics key access. The electronics key access may be wireless, for example, using the wireless communication interface 114. In some embodiments, the safe system 100 may include two locks. A lock 208 may be operated by a mechanical key, or analog, or by a combination lock, or a combination of a mechanical key and combination lock. The second lock (or user interface) 208 is electronics lock that may be operated by user device 230, e.g., using wireless communication. In some embodiments, the lock 208 may use biometrics. Biometric identification authenticates secure entry, data or access via human biological information, such as fingerprints, facial features, voice, or DNA.

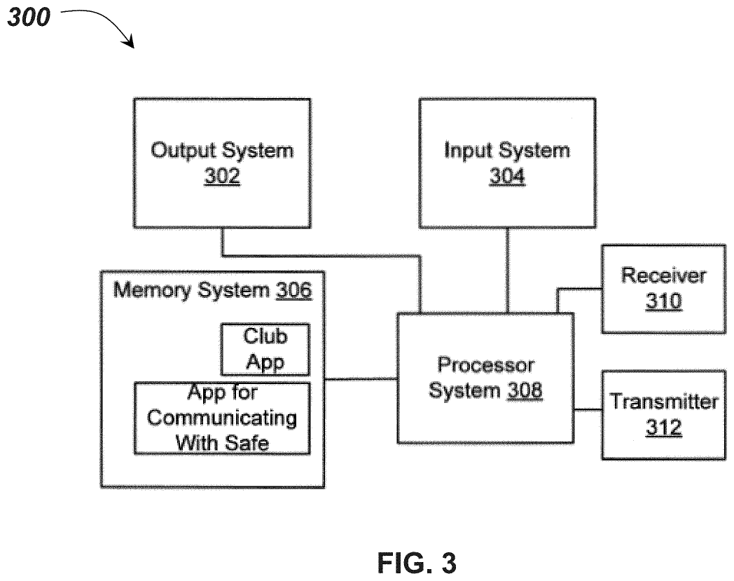

FIG. 3 illustrates an exemplary block diagram of system 300 of a user device 230, according to some aspects of the disclosure. In some embodiments, the system 300 may include output system 302, input system 304, memory system 306, processor system 308, receiver 310, and transmitter 312. System 300 may include additional components and/or may not include all of the components listed above. Output system 302 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 304 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Memory system 306 may include, for example, any one of, some of, any combination of, or all of a long term storage system, such as a hard drive; a short term storage system, such as random access memory; a removable storage system, such as a removable drive; and/or flash memory. Memory system 306 may include one or more machine-readable mediums that may store a variety of different types of information. The term machine-readable medium is used to refer to non-transitory computer readable memory, capable carrying information that is readable by a machine. Memory 306 may store an application for communicating with the safe system 100 and/or the server 210. The application may also perform other functions as described herein, for example, a membership club application.

Processor system 308 may include any one of, some of, any combination of, or all of multiple parallel processors, a single processor, a system of processors having one or more central processors and/or one or more specialized processors dedicated to specific tasks. Processor system 308 receives input from input system 304 and sends output to output system 302. Processor system 308 retrieves machine instructions from memory system 306 and implements the machine instructions. Processor 308 may implement the app stored in memory system 306 for performing functions described herein, for example, locking and unlocking the safe system 100, operating the safe system 100, and communicating with server 210, executing a membership club application, and so on.

Receiver 310 receives electrical and/or other signals from a network for communicating with other devices, such as the server 210 and safe system 100, via the network. In some embodiments, receiver 310 may receive signals directly from the safe system 100.

Transmitter 312 transmits signals through a network for communicating with other devices, such as the server 210 and safe system 100. In some embodiments, transmitter 310 may transmit signals directly to the safe system 100.

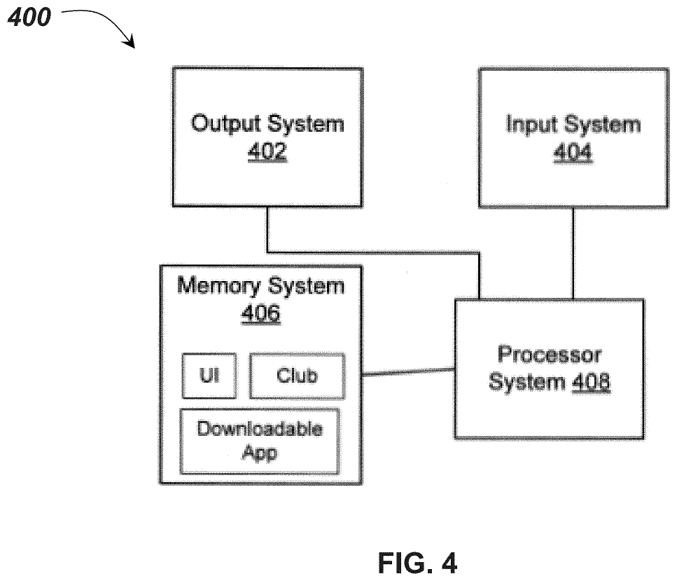

FIG. 4 illustrates an exemplary block diagram of system 400 of the server system 210, according to some aspects of the disclosure. The server system 400 may include output system 402, input system 404, memory system 406, and processor system 408. In some embodiments, server system 400 may include additional components and/or may not include all of the components listed above.

Output system 402, input system 404, memory system 406, and processor system 408 may be similar to output system 302, input system 304, memory system 306, and processor system 308. Memory system 406 may store a downloadable version of the app 215 and other software described herein. Processor 408 may implement code stored in memory system 406 for performing functions described herein, for example, communicating with user devices.

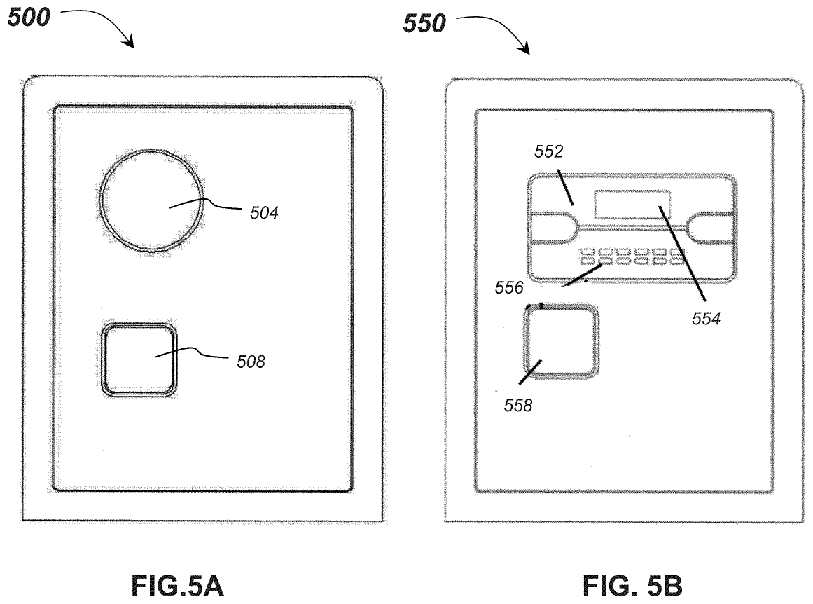

FIG. 5A illustrates an exemplary front view of a climate controlled safe system 500, according to some aspects of the disclosure. This front view shows the front of the safe body. In some embodiments, the system 500 front may include a user interface 504 and a handle 508. As described herein, the user interface 504 may provide an electronic lock or biometric lock, and the handle 508 may provide an analog mechanical lock.

FIG. 5B illustrates another exemplary front view of a climate controlled safe system 550, according to some aspects of the disclosure. This front view shows the front of the safe body. In some embodiments, the system 550 front may include a user interface 552 and a handle 558. As described herein, the user interface 552 may provide an electronic or biometric lock, and the handle 558 may provide an analog mechanical lock. The user interface may include display 554, and keypad 556.

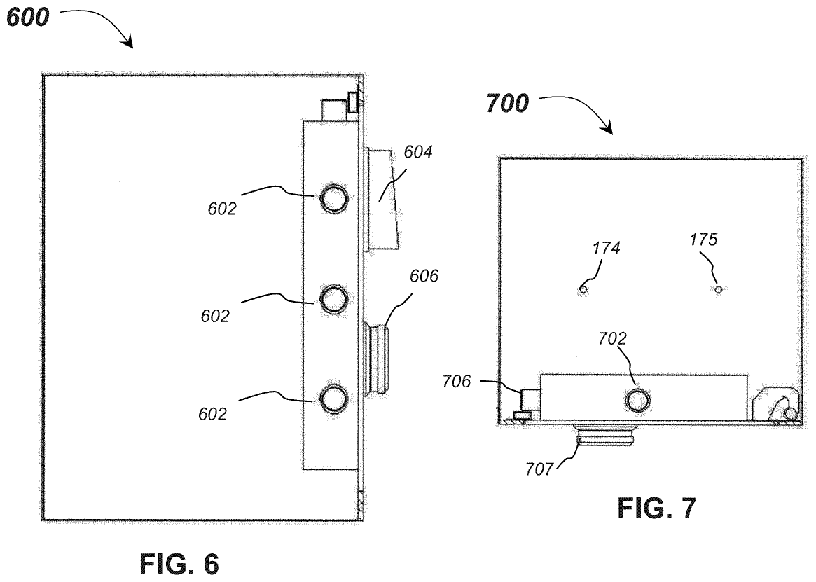

FIG. 6 illustrates an exemplary sectional side view 600 of the climate controlled safe system 100, according to some aspects of the disclosure. In some embodiments, the safe may include a plurality of bolts 602, which may be installed in the door 196 of the safe body. The side view also illustrates user interface 604 and handle 606.

FIG. 7 illustrates an exemplary sectional bottom view 700 of the climate controlled safe system 100, according to some aspects of the disclosure. In some embodiments, safe may include a plurality of bolts 702 and 706, which may be installed in the door 196 of the safe body. The bottom view also illustrates handle 707. The bottom of the safe body may also include holes 174, 175 for attaching the safe body to a structure, such as a floor.

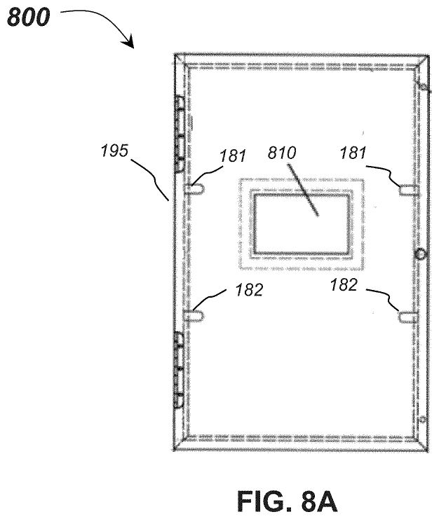

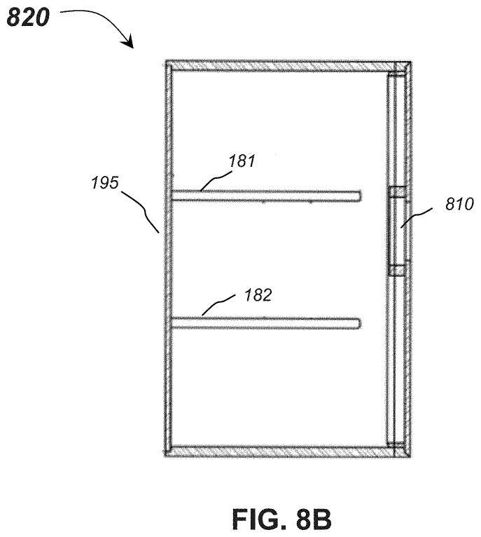

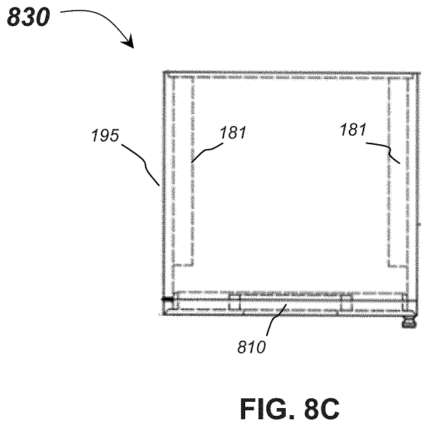

FIG. 8A illustrates an exemplary sectional view 800 of the insert 195 that may fit in a climate controlled safe body, according to some aspects of the disclosure. In some embodiments, as shown above, the insert 195 may include upper rails 181 and lower rails 182. The door of the insert 195 may include an aperture 810 for receiving the measurement unit 197.

FIG. 8B illustrates an exemplary sectional side view 820 of the insert 195 that may fit in a climate controlled safe body, according to some aspects of the disclosure. In some embodiments, as shown above, the insert 195 may include upper rails 181 and lower rails 182. The door of the insert 195 may include an aperture 810 for receiving the measurement unit 197.

FIG. 8C illustrates an exemplary sectional top view 830 of the safe insert 195 that may fit in a climate controlled safe body, according to some aspects of the disclosure. In some embodiments, as shown above, the insert 195 may include upper rails 181. The door of the insert 195 may include an aperture 810 for receiving the measurement unit 197.

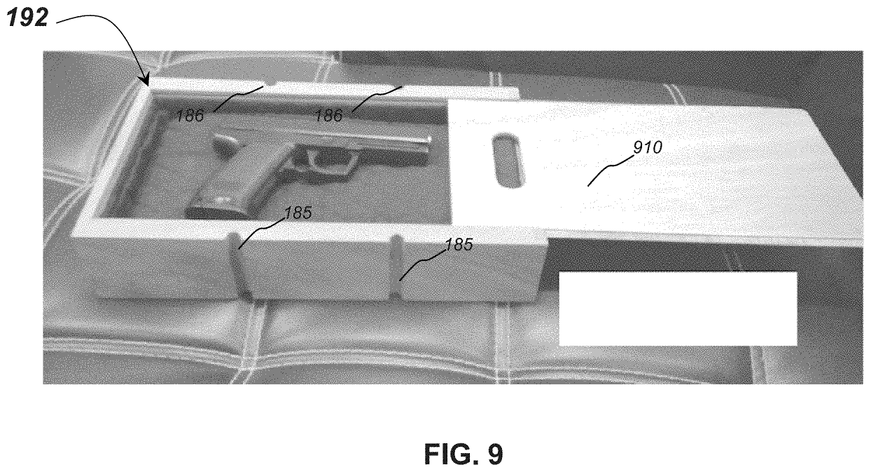

FIG. 9 illustrates an exemplary perspective view of the vertical storage box 192 of a climate controlled safe system, according to some aspects of the disclosure. The box 192 ma include opposite grooves 185, 186 for receiving corresponding rails 182, 182 of the insert 195. The box 192 may include removable sliding lid 910 and store items such as herbs, plants, guns, etc.

In some embodiments, the purchaser/user of the safe system 100 described above may have the option of participating, using the downloadable app 215, in a user's club for the substance of choice. The server 210 may store a user interface that the user may use for setting up a membership in a club for sharing or purchasing the herbs, plants and/or other substances and items. In some embodiments, purchasers/users of the safe system 100 may join a club for receiving and using herbs, plants or other substances, or other items. The club member may periodically (e.g., once of month) receive a multiplicity of different products having the substance of interest, and for a number of consecutive periods, each time a delivery is sent, a different set of products having the substance may be sent, unless the user specifically requests that a particular product be delivered. The products delivered as part of the club may be stored in one of the safe systems of this disclosure. In some embodiments, upon purchasing one of the safe systems 100, the user obtains a membership for the club. In some embodiments, there may be a server, e.g., server 210 as described above, via which the user signs up for the club. The user may enter a serial number of a medical card that authorizes the user to purchase the substance and a username. The server may automatically check a database at a remote location (e.g., at a government office) to determine whether the serial and username match one another. If the serial number and username match, then the user is enrolled in the club. If the serial number and username do not match, then the user is denied permission to enroll in the club.

The user may also use the app 215 or another user device for communicating with the server regarding the herb or plant club, such as by setting preferences related to payment options, how often and where the herbs, plants, and/or other substances are delivered, in addition to the strains of plants or plants that are delivered.

One or more of the components, processes, features, and/or functions illustrated in the figures may be rearranged and/or combined into a single component, block, feature or function or embodied in several components, steps, or functions. Additional elements, components, processes, and/or functions may also be added without departing from the disclosure. The apparatus, devices, and/or components illustrated in the Figures may be configured to perform one or more of the methods, features, or processes described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The enablements described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

It should be noted that where a discrete value or range of values is set forth herein (e.g., 5, 6, 10, 100, etc.), it is noted that the value or range of values may be claimed more broadly than as a discrete number or range of numbers, unless indicated otherwise. Any discrete values mentioned herein are merely provided as examples.

1. A climate controlled safe system, comprising:
a safe body;
a safe door pivotly coupled to the safe body;
an insert removably coupled to the safe body; and
wherein the insert further comprises an insert body, an insert door pivotly coupled to the insert body, and further wherein the insert door includes a removable climate control unit and a removable hygrometer.

2. The climate controlled safe system of claim 1, wherein the climate control unit includes one of temperature control, humidity control, and oxygen control.

3. The climate controlled safe system of claim 1, wherein the insert body includes one or more rails for receiving one or more storage trays.

4. The climate controlled safe system of claim 1, wherein the insert body includes two sets of rails for receiving a vertical storage box.

5. The climate controlled safe system of claim 4, wherein the vertical storage box includes two sets of grooves for receiving the two sets of rails of the insert body.

6. The climate controlled safe system of claim 4, wherein the insert body receives three vertical storage boxes.

7. The climate controlled safe system of claim 4, wherein the vertical storage box includes a removable lid.

8. The climate controlled safe system of claim 1, wherein the climate control unit is a humidifier.

9. The climate controlled safe system of claim 8, wherein the humidifier includes a solution of polyglycol.

10. The climate controlled safe system of claim 1, wherein the safe body includes a vertical back side having one or more holes for mounting the safe body on a vertical structure.

11. The climate controlled safe system of claim 1, wherein the safe body includes a horizontal bottom side having one or more holes for mounting the safe body on a horizontal structure.

12. The climate controlled safe system of claim 1, wherein the safe door includes a wireless lock.

13. The climate controlled safe system of claim 1, wherein the safe door includes a biometric lock.

14. The climate controlled safe system of claim 1, wherein the safe door includes an analog lock.

15. The climate controlled safe system of claim 12, wherein the safe door is operated from a wireless device.

16. A climate controlled safe system, comprising:
a safe body, the safe body includes a vertical back side having one or more holes for mounting the safe body on a vertical structure, a horizontal bottom side having one or more holes for mounting the safe body on a horizontal structure;
a safe door pivotly coupled to the safe body;
an insert removably coupled to the safe body;
wherein the insert further comprises an insert body, an insert door pivotly coupled to the insert body, and further wherein the insert door includes a removable climate control unit and a removable hygrometer; and
wherein the insert body includes one or more rails for receiving one or more storage trays or one or more vertical storage boxes.

17. The climate controlled safe of claim 16, wherein the climate control unit includes one of temperature control, humidity control, and oxygen control.

18. The climate controlled safe system of claim 16, wherein the climate control unit is a humidifier.

19. The climate controlled safe system of claim 16, wherein the safe door includes a wireless lock.

20. The climate controlled safe system of claim 19, wherein the safe door is operated from a wireless device.
